(19) United States
(12) Patent Application Publication
(10) Pub. No.: US 2019/0191205 A1
(43) Pub. Date: Jun. 20, 2019

(54) VIDEO SYSTEM WITH SECOND SCREEN INTERACTION

(71) Applicant: AT&T Intellectual Property I, L.P., Atlanta, GA (US)

(72) Inventors: David B. DeLorme, Stone Mountain, GA (US); Dale W. Malik, Atlanta, GA (US); David Purcell, Alpharetta, GA (US)

(21) Appl. No.: 15/847,728

(22) Filed: Dec. 19, 2017

(51) Int. Cl. H04N 21/41; H04N 21/845; H04N 21/4363; H04N 21/45; H04N 21/472

(52) U.S. Cl. CPC H04N 21/4122; H04N 21/8456; H04N 21/47202; H04N 21/4532; H04N 21/47217; H04N 21/43637

(57) ABSTRACT

Devices, computer-readable media, and methods for presenting a secondary content in connection with a presentation of a video program on a primary screen device are disclosed. For example, a processing system may receive a timed event metadata set associated with a video program, receive a timestamp associated with the video program from a primary screen device, and detect that the timestamp matches a timed event record from the timed event metadata set. The processing system may additionally access a secondary content in accordance with the timed event record in response to the detecting and present the secondary content on a screen of the device.

The present disclosure relates generally to the presentation of video programs, and more particularly to devices, non-transitory computer-readable media, and methods for presenting a secondary content in connection with a presentation of a video program on a primary screen device and to devices, non-transitory computer-readable media, and methods for presenting a video program via a primary screen device in connection with a second screen device for presenting a secondary content.

### BACKGROUND

Television service providers offer a number of options to subscribers for obtaining and presenting video programs. For example, a subscriber may view video programs that are provided by various content sources and broadcast by a television service provider. In addition, a subscriber may stream or download a video program in connection with a video on demand (VOD) service of the television service provider to a set top box for presentation on a television. A subscriber may also stream or download video programs from another entity, e.g., an over the top (OTT) provider, a video hosting web server, and so forth. In addition, a subscriber may record video programs to a digital video recorder (DVR) or to another subscriber device, where the video programs may be broadcast by the television service provider, or which may be purchased, rented, or rights otherwise obtained by the subscriber. The subscriber may then play back the recorded video programs at the subscriber's convenience.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an example system for presenting a secondary content in connection with a presentation of a video program on a primary screen device, in accordance with the present disclosure;

FIG. 3 illustrates a portion of an example timed event metadata set, in accordance with the present disclosure;

FIG. 4 illustrates a flowchart of an example method for presenting a secondary content in connection with a presentation of a video program on a primary screen device;

FIG. 5 illustrates a flowchart of an example method for presenting a video program via a primary screen device in connection with a second screen device for presenting a secondary content; and

FIG. 6 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Various options are available for a user to playback digital video programs. This includes video programs stored on an on-premises device or streamed from one or more servers over a network to set-top boxes, mobile devices, and so forth. For video streamed to a primary screen device, such as a television, a tablet, a laptop computer screen or desktop computer screen, and so forth, secondary content can be sent to a second screen device, such as a computing tablet, a smartphone, a Wi-Fi device, or the like.

In one example, the present disclosure describes a device, computer-readable medium and method for presenting a secondary content in connection with a presentation of a video program on a primary screen device. For instance, in one example, a processing system may receive a timed event metadata set associated with a video program, receive a timestamp from the video program from a primary screen device, and detect that the timestamp matches a timed event record from the timed event metadata set. The processing system may additionally access a secondary content in accordance with the timed event record in response to the detecting and present the secondary content on a screen of the device.

In another example, the present disclosure describes a device, computer-readable medium and method for presenting a video program via a primary screen device in connection with a second screen device for presenting a secondary content. For instance, in one example, a processing system may establish a wireless communication session with a second screen device, transmit a notification to the second screen device when a presentation of a video program is to begin, and present the video program. The processing system may further transmit a timestamp from the video program to the second screen device, receive an instruction from the second screen device to pause the video program when a secondary content is being presented on the second screen device, and pause the video program in accordance with the instruction.

In one example, the present disclosure provides a timed event metadata set containing timed event records (broadly “event information”) associated with a video program to be presented on a primary screen device. In one example, the timed event metadata set is utilized to coordinate the display of secondary content with the video program presented via the primary screen device. In one example, timed event records control which secondary content is sent to a second screen device, when the primary screen device should pause, resume, or change the presentation of a video content, and so forth. In one example, the primary screen device periodically sends timestamps to the second screen device, where the timestamps contain the current time of the video program as it is played on the primary screen device. For instance, the primary screen device may begin sending timestamps when the presentation of the video program begin, and continue to send the timestamps (e.g., at regular intervals) as the presentation of the video program continues. When the second screen device determines that a timestamp matches a timed event record, the second screen device may launch the timed event record. The timed event record may be for presenting or displaying on the second screen device one or more of: additional program information related to the video program, advertisements, interactive electronic content, such as social media content, quizzes, polling, food ordering, and so forth. In one example, the presentation of secondary content on a second screen device may cause the presentation of the video program on the primary screen device to automatically pause. For instance, the second screen device may transmit an instruction to the primary screen device to pause the video program when the secondary content is presented on the second screen device. Accordingly, in one example, messaging between the primary screen device and secondary screen device is bi-directional.

In one example, the same second screen experience is provided to viewers regardless of when the video program is watched. For instance, where a timed event record is for presenting social media content, such as interactive comments, the second screen device may present the comments that are related to that point in the video program, e.g., no spoilers. Thus, viewers may watch a rerun of a video program (or a recorded or streaming video program), but may still receive secondary content that is relevant to the points in the video program as these points are reached by the viewer.

In one example, a context engine on the second screen device filters secondary contents to select a secondary content to present that is most relevant to the user. For instance, the context engine may contain specific information about the viewer's preferences, interests, location, calendar/schedule, and so forth. In one example, the context engine may inspect the event information of the timed event record and determine the most appropriate secondary content to display on the second screen device based on the viewer-specific information. For example, if the event is an advertisement, the context engine may determine which advertisement is most appropriate for a viewer based on the viewer's interests and/or other factors pertaining to the current situation. For example, if it is dinnertime, the secondary content may be an advertisement or an interface for ordering a pizza. In another circumstance, a different advertisement could be selected in accordance with the viewer's preferences/profile, and based upon the event information of the timed event record.

In one example, multiple second screen devices may be engaged with the primary screen device in connection with the presentation of the video program on the primary screen device. For instance, the primary screen device may have multiple viewers watching and one or more second screen devices (e.g., for one or more viewers) may be for presenting secondary contents associated with the video program. Thus, for example, where the timed event record is for presenting a commercial, different commercials may be presented on different second screen devices, e.g., based upon the different viewers' interests and based upon the event information of the timed event record such as commercials tailored for male viewers, female viewers, teenage viewers, interests of individual viewers, and so on.

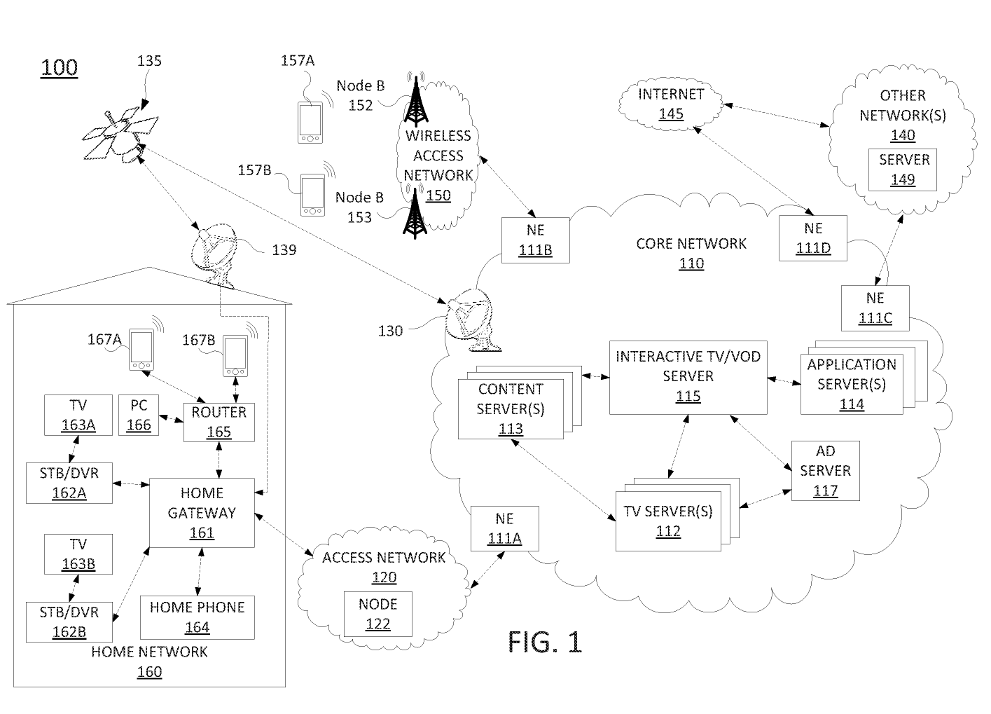

In one example, the timed event metadata set is provided to the second screen device by the primary screen device. In another example, the timed event metadata set is provided to the second screen device by a network-based server. In one example, each timed event record in the timed event metadata set contains a start time field referencing a particular point in the video program, an event category, and at least one identifier, such as a uniform resource locator (URL) for obtaining an advertisement from a network-based server. The network-based server may be the same or a different server from which the timed event metadata set is obtained. The event category may be additional program information related to the video program, advertisements, interactive electronic content, and so forth. In addition, the timed event metadata set may contain additional data for executing each event. For example, if the event category is an advertisement, the data for executing the event may include multiple URLs for obtaining different advertisements from a network-based server as well as criteria for selecting a particular URL/advertisement, e.g., based upon a viewer's interests. These and other aspects of the present disclosure are described in greater detail below in connection with the examples of FIGS. 1-6.

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140 and/or the Internet 145.

In one embodiment, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE), 5G or any other yet to be developed future wireless/cellular network technology. While the present disclosure is not limited to any particular type of wireless access network, in the illustrative embodiment, wireless access network 150 is shown as a UMTS terrestrial radio access network (UTRAN) subsystem. Thus, elements 152 and 153 may each comprise a Node B or evolved Node B (eNodeB).

In one example, each of the mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one embodiment, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple-play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (ad server) 117, and an interactive TVNOD server 115 (e.g., an application server). For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may interact with content servers 113, advertising server 117, and interactive TVNOD server 115 to select which video programs, or other content and advertisements to provide to the home network 160 and to others.

In one example, content servers 113 may store scheduled television broadcast content for a number of television channels, video-on-demand programming, local programming content, and so forth. For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to viewers, e.g., in the home network 160 and at other downstream viewing locations. For example, advertisers may upload various advertising content to the core network 110 to be distributed to various viewers.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another embodiment node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

As illustrated in FIG. 1, core network 110 may include various application servers 114. For instance, application servers 114 may be implemented to provide certain functions or features, e.g., a Serving-Call Session Control Function (S-CSCF), a Proxy-Call Session Control Function (P-CSCF), or an Interrogating-Call Session Control Function (I-CSCF), one or more billing servers for billing one or more services, including cellular data and telephony services, wire-line phone services, Internet access services, and television services. Application servers 114 may also include a Home Subscriber Server/Home Location Register (HSS/HLR) for tracking cellular subscriber device location and other functions. An HSS refers to a network element residing in the control plane of an IMS network that acts as a central repository of all customer specific authorizations, service profiles, preferences, etc. Application servers 114 may also include an IMS media server (MS) for handling and terminating media streams to provide services such as announcements, bridges, and Interactive Voice Response (IVR) messages for VoIP and cellular service applications. The MS may also interact with customers for media session management. In addition, application servers 114 may also include a presence server, e.g., for detecting a presence of a user. For example, the presence server may determine the physical location of a user or whether the user is “present” for the purpose of a subscribed service, e.g., online for a chatting service and the like. Application servers 114 may further include business information database (BID) storage servers. For instance, the network operator of core network 110 may receive and store third-party information relating to subscribers. In one example, application servers 114 may represent a distributed file system.

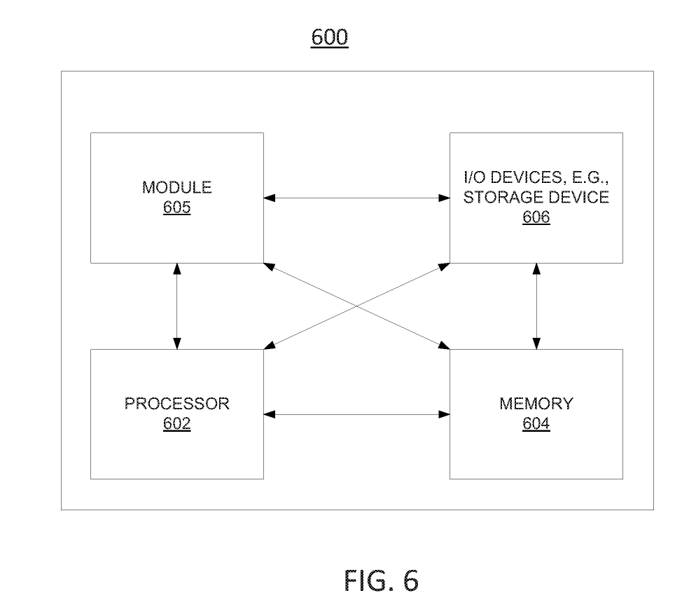

In one example, application servers 114 may include data storage servers to receive, store, and/or provide timed event metadata sets regarding the video programs (e.g., movies, television programming, and etc.) maintained within content servers 113 and/or other video programs. In one example, application servers 114 may alternatively or additionally include data storage servers to receive, store, and/or provide secondary content in connection with requests from second screen devices. In one example, each of application servers 114 may comprise a computing system or server, such as computing system 600 depicted in FIG. 6, and may be configured to provide one or more operations or functions for presenting a secondary content in connection with a presentation of a video program on a primary screen device, as described herein. It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. It should also be noted that the foregoing are only several examples of the types of relevant application servers 114 that may be included in core network 110 for storing information relevant to examples of the present disclosure for presenting a secondary content in connection with a presentation of a video program on a primary screen device, as described herein.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

In one example, one or both of the STB/DVR 162A and STB/DVR 162B may comprise a computing system or server, such as computing system 600 depicted in FIG. 6, and may be configured to provide one or more operations or functions for presenting a video program via a primary screen device in connection with a second screen device for presenting a secondary content, as described herein. STB/DVR 162A and/or STB/DVR 162B may also be configured to provide one or more operations or functions in connection with examples of the present disclosure for presenting a secondary content in connection with a presentation of a video program on a primary screen device, as described herein. For example, one or both of the STB/DVR 162A and STB/DVR 162B may host an operating system for presenting a user interface via TVs 163A and 163B, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components. In one example, STB/DVR 162A and/or STB/DVR 162B may also provide a web browser for obtaining video programs from servers hosting such video programs, and for making such video programs available via the Internet 145. For instance, in one example, server 149 in other networks 140 may represent such a web server. In one example, the web browser may comprise a limited web browser that is restricted to accessing certain approved web sites providing video programs.

In one example, STB/DVR 162A and/or STB/DVR 162B may comprise a primary screen device in accordance with the present disclosure. In accordance with the present disclosure, television content, whether received via satellite receiver 139 or via access network 120 may comprise video content to be presented on a primary screen device. In addition, in one example, mobile device 167A and/or mobile device 167B may comprise a second screen device in accordance with the present disclosure. In this regard, it should be noted that mobile devices 167A and 167B may also comprise a computing system, such as computing system 600 depicted in FIG. 6, and may be configured to provide one or more operations or functions for presenting a secondary content in connection with a presentation of a video program on a primary screen device, as described herein.

In one example, a network-based sever for providing a timed event metadata set may include interactive TVNOD server 115, content severs 113, application servers 114, server 149, and so forth. In addition, in one example, a network-based server for providing secondary content in connection with a presentation of a video program on a primary screen device may comprise the same network-based sever for providing the timed event metadata set or a different network-based server (which may comprise any one or more of interactive TVNOD server 115, content severs 113, application servers 114, advertising server 117, server 149, etc.).

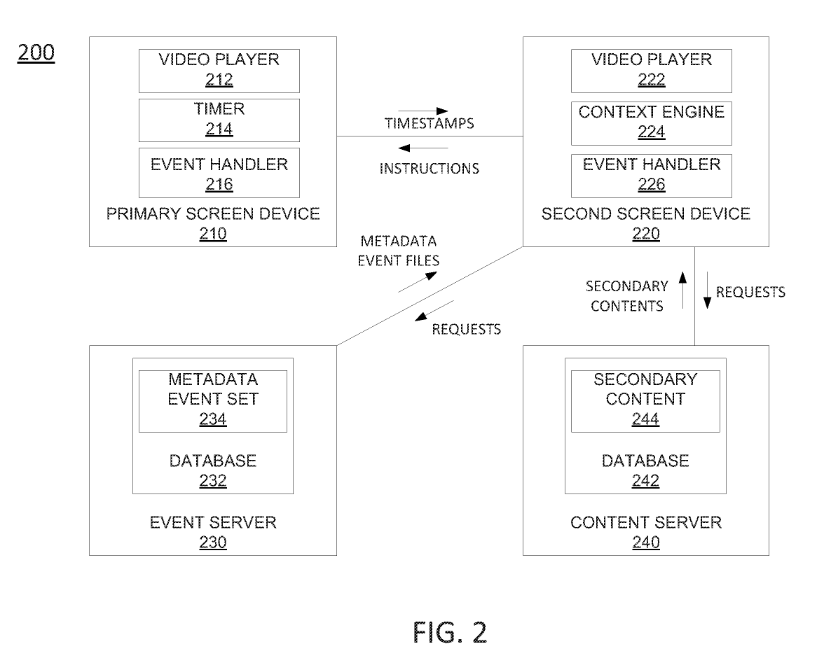

Further details regarding the functions that may be implemented by interactive TVNOD server 115, STBs/DVRs 162A and 162B, mobile devices 167A and 167B, and so on are discussed in greater detail below in connection with the examples of FIGS. 2-5. In addition, those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

FIG. 2 illustrates an example system 200 for presenting a secondary content in connection with a presentation of a video program on a primary screen device, in accordance with the present disclosure. The system 200 includes a primary screen device 210, a second screen device 220, an event server 230, and a content server 240. As illustrated in FIG. 2, the event server 230 includes a database 232 (e.g., comprising one or more physical storage devices) that includes timed event metadata sets associated with various video programs, such as timed event metadata set 234. The content server 240 includes a database 242 (e.g., comprising one or more physical storage devices) that includes secondary content that may be referenced in timed event metadata sets, such as secondary content 244. The event server 230 and content server 240 may both comprise network-based processing systems including one or more physical devices. For instance, event server 230 and/or content server 240 may be represented by application servers 114, interactive TVNOD server 115, advertising server 117, and/or server 149 in FIG. 1. In one example, event server 230 and/or content server 240 may comprise a cloud-based and/or distributed data storage system comprising one or more servers at a same location or at different locations. However, for ease of illustration, an example where timed event metadata sets and secondary content are stored on standalone servers is shown in FIG. 2.

The primary screen device 210 may comprise, for example, a set-top box or a set-top box/DVR combination (coupled to a television or other display screen), a smart television, a personal computer, a laptop computer, a tablet computer, and so forth. For instance, the primary screen device 210 may be represented by STB/DVR 162A, STB/DVR 162B, PC 166, TV 163A, or TV 163B in FIG. 1. The second screen device 220 may comprise a laptop computer, a tablet computer, a smart phone, a handheld Wi-Fi device, a pair of smart glasses, and so forth. For instance, the second screen device 220 may be represented by PC 166, mobile device 167A, or mobile device 167B in FIG. 1.

As illustrated in FIG. 2, the primary screen device 210 includes a video player 212, a timer 214, and an event handler 216. The second screen device 220 includes a video player 222, a context engine 224, and an event handler 226. In one example, the primary screen device 210 and second screen device 220 may establish a wireless communication session between the devices in connection with a presentation of a video program on the primary screen device 210. The video program may comprise a live broadcast television program, a recorded video program that is played back from a DVR, an on-demand/streaming video program, an IPTV video program that is streamed and/or downloaded from a web server, and so forth. The wireless communication session may comprise a peer-to-peer or local network-based wireless link, such as an IEEE 802.15 based link (e.g., Bluetooth, ZigBee, etc.), an IEEE 802.11 based link (e.g., Wi-Fi or Wi-Fi Direct), and so on.

The wireless communication session may be initiated by either or both of the primary screen device 210 and the second screen device 220. For example, the second screen device 220 may include an application that provides an interface for a viewer to initiate the establishment of the wireless communication session with the primary screen device 210. In another example, the primary screen device may include an application that provides an interface via the primary screen device 210 for the viewer associated with second screen device 220, or another viewer, to contact any second screen devices within wireless communication range (e.g., including second screen device 220) to establish the wireless communication session. In such an example, an application on second screen device 220 may provide an interface to present a notification of a pairing request from the primary screen device 210, and to allow the viewer associated with second screen device 220 to select an option to permit the pairing. It should be noted that in one example, primary screen device 210 may establish wireless communication sessions with a plurality of second screen devices. However, for ease of illustration, FIG. 2 illustrates only a single second screen device 220 in communication with primary screen device 210.

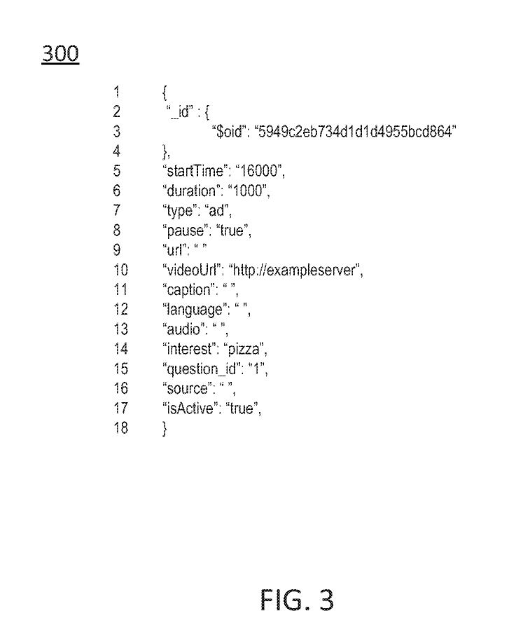

In one example, the primary screen device 210 may send a notification to the second screen device 220 via the wireless communication session when the primary screen device 210 is to present a video program. In one example, the second screen device 220 may obtain a timed event metadata set associated with the video program from event server 230 (e.g., timed event metadata set 234) in response to receiving the notification that the video program is to be presented. In one example, the second screen device 220 may transmit a request to the event server 230 with an identification of the video program. The event server 230 may then retrieve the corresponding timed event metadata set 234 from database 232 and transmit the timed event metadata set back to the second screen device 220. It should be noted that in another example, the primary screen device 210 may request and receive timed event metadata set 234 from event server 230, or may receive timed event metadata set 234 along with the video program from a server from which the video program is obtained. In such an example, the primary screen device 210 may provide the timed event metadata set 234 to the second screen device 220 via the wireless communication session. An example portion of a timed event metadata set is illustrated in FIG. 3 and discussed in greater detail below.

As the primary screen device 210 begins to present the video program (e.g., via an integrated or attached display screen), the timer 214 periodically sends timestamps to second screen device 220, e.g., once per second, once every five seconds, etc., via the wireless communication session. The timestamps include information associated with the elapsed time within the video program that is being presented via the primary screen device (e.g., the time of a current frame, a value representing a time of an approaching frame, e.g., 5 seconds in advance of a particular frame, and so forth). In this way, the second screen device 220 is synchronized with the video content on the primary screen device 210.

The event handler 226 of the second screen device 220 may receive the timestamps and may parse the timed event metadata set 234 to detect if a time indicated in a timestamp matches a particular timed event record in the timed event metadata set 234. In one example, when the event handler 226 detects that a timestamp matches a timed event record, the event handler 226 may send an instruction to primary screen device 210 to pause the video program that is being presented on the primary screen device 210. In one example, the event handler 216 of primary screen device 210 may receive the instruction and communicate with the video player 212 to pause the video program. In another example, the video program may continue on the primary screen device 210 (e.g., without pausing), while the second screen device 220 continues to process the timed event record.

When the event handler 226 detects that a timestamp matches a timed event record, the event handler 226 may also invoke the context engine 224 to select and present secondary content to be presented via the second screen device 220. For example, the context engine 224 may utilize the timed event record to select secondary content 244, to select content server 240, and/or to make a request for a particular type of secondary content from content server 240. For instance, different content servers may be provided for different types of content, different subject matter of the secondary contents, and so forth. In one example, the event handler 226 may, in accordance with the timed event record, consider a viewer profile in order to personalize or tailor the secondary content to the viewer. For instance, a timed event record may be for the presentation of a sports team advertisement. However, the viewer may have a known preference for one team over another. Accordingly, in one example, the timed event record may provide for the selection by the context engine 224 between secondary content associated with a first team and secondary content associated with a second team (or several other teams).

In one example, the viewer profile may be stored locally at second screen device 220. Thus, the personalization (e.g., the process of selecting a particular secondary content, content subject matter, and/or content server) may be based upon the timed event record in the timed event metadata set 234, but may maintain a level of privacy of the viewer profile with respect to any network-based devices. In the present example, the request may be transmitted to content server 240, which may retrieve secondary content 244 from database 242 and transmit the secondary content 244 back to second screen device 220. It should be noted that in another example, the timed event record may provide for the context engine 224 to obtain multiple secondary contents from the same or different servers which may be presented sequentially or in combination. For instance, an audio stream and a video stream may be store separately. For example, different audio streams may be provided to different second screen devices, such as different language versions of a same advertisement.

The secondary content 244 may comprise for example, audio, video, or interactive content, such as: additional program information related to the video program, advertisements, interactive electronic content, such as social media content, quizzes, polling, food ordering, and so forth. In an example where the secondary content 244 comprises video content, video player 222 may begin to present the secondary content 244 (e.g., via an integrated or attached display screen) when it is received at second screen device 220. In other examples, the secondary content 244 may be presented via an integrated or attached display screen, one or more audio speakers, headphones, and so forth, e.g., depending upon the particular type of the secondary content 244. When the presentation of the secondary content 244 in accordance with the timed event record is ended, in one example, the event handler 226 may send an additional instruction to the primary screen device 210 via the wireless communication session to resume play of the video program. The instruction may be received by event handler 216, which may cause the video player 212 to resume the play of the video program via the primary screen device.

To further aid in understanding the present disclosure, FIG. 3 illustrates a portion of an example timed event metadata set, e.g., timed event record 300. The timed event record 300 may take various forms to represent the same type of information. For instance, the timed event record 300 is not limited to any particular type of syntax. However, in one example, the timed event record 300 may be provided in Java Script Object Notation (JSON). In another example, the timed event record 300 may be provided as an eXtensible Markup Language (XML) form. In the example of FIG. 3, the timed event record 300 includes various event information, such as: a timed event identifier (e.g., lines 2-4), a start time (e.g., line 5), a duration (e.g., line 6), and an identification of secondary content (e.g., line 9 and/or line 10). Line 7 indicates a type or category of timed event, which in this case is an advertisement (“ad”). For instance, at a particular elapsed time or frame in a video program, the presentation of an advertisement may be provided for in accordance with timed event record 300. For example, the start time may be at 16000 milliseconds into the video program. In one example, an event handler of a second screen device may inspect the “startTime” field and determine if the time matches a time that is indicated in a timestamp received from a primary screen device. In one example, when a match is detected, the event handler may invoke a context engine to continue operations with respect to timed event record 300.

In the present example, line 9 includes a null value, while line 10 includes a URL link to a video. For instance, in one example, line 9 may provide a field “url” for interactive or text based content, while line 10 may comprise a field “videoUrl” that is particularized for URLs where the secondary content includes video content. Lines 11-13 may provide for options relating to video captioning (e.g., line 11), a particular language (e.g., line 12), and audio track (e.g., line 13). Other fields may relate to secondary content comprising quizzes or surveys (e.g., line 15) a particular content server from which to retrieve secondary content (e.g., line 16 “source”), and so forth. Line 17 includes an “isActive” field which may be used to enable and disable certain timed event records. For instance, a television service provider may temporarily provide for a video program to be presented without advertisements by changing the “isActive” field of timed event records of the type “ad” to be “false” instead of “true.” Thus, for example, any second screen devices requesting the timed event metadata set during a promotional period may receive the timed event metadata set with the timed event record 300 being effectively disabled.

In addition, line 14 includes an “interest” field and in one example may be used to select between different secondary content depending upon a viewer profile and the interests of a particular viewer. In such an example, the timed event record 300 may be expanded to include different URLs, different video URLs, and the like to be associated with different “interest” categories. In addition, in such an example, the context engine of a second screen device may inspect the contents of the timed event record 300 to match the interest of a viewer (e.g., according to a stored viewer profile/preferences), to determine a particular secondary content, and to request and obtain the secondary content from an appropriate network-based server. It should also be noted that in one example, fields, such as “caption,” “language,” or the like may be referenced and a selection may be made in accordance with a viewer profile to include various parameters in requests for secondary content from a network-based server. For instance, a Hypertext Transfer Protocol (HTTP) “get” request may include the “videoUrl” of line 10 and may further include an identification of a preferred language in the request. As such, different second screen devices that are paired with a primary screen device may independently determine that a timestamp matches timed event record 300, but may make different requests for secondary content in accordance with timed event record 300 based upon the differences in the viewers' profiles and preferences.

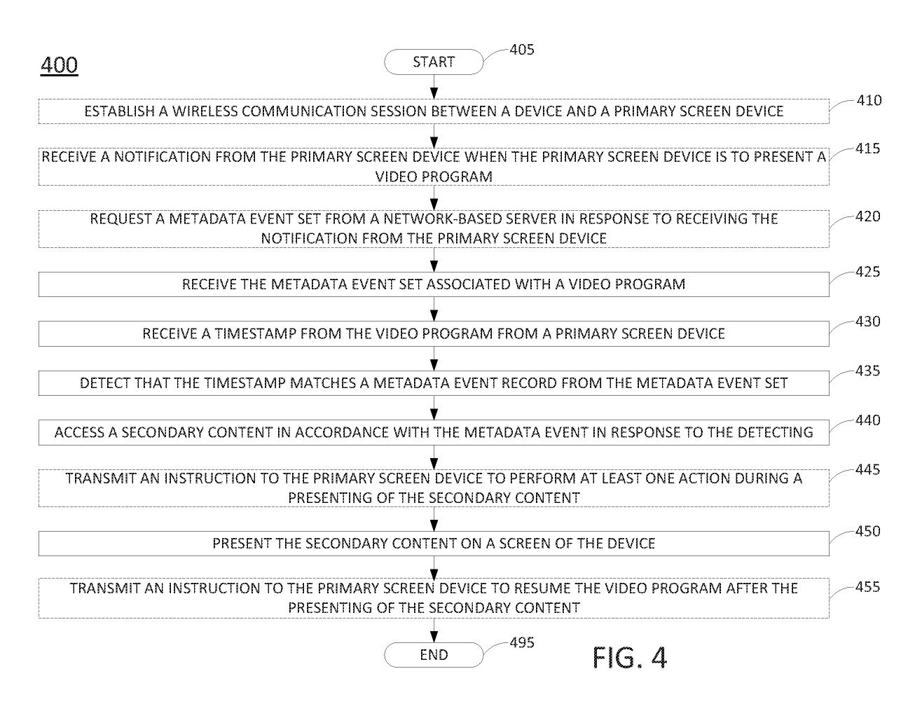

FIG. 4 illustrates a flowchart of a method 400 for presenting a secondary content in connection with a presentation of a video program on a primary screen device, in accordance with the present disclosure. In one example, the method 400 is performed by a second screen device, or any one or more components thereof (such as a context engine, and event handler, etc., e.g., a processor performing operations in accordance with instructions loaded into a memory), or by a second screen device in conjunction with one or more other devices, such as a primary screen device, an event server, a content server, and so forth. In one example, the steps, functions, or operations of method 400 may be performed by a computing device or system 600, and/or a processing system 602 as described in connection with FIG. 6 below. For instance, the computing device 600 may represent at least a portion of a second screen device, or a system for presenting a secondary content in connection with a presentation of a video program on a primary screen device, in accordance with the present disclosure. For illustrative purposes, the method 400 is described in greater detail below in connection with an example performed by a processing system, such as processing system 602. The method 400 begins in step 405 and may proceed to any one of optional steps 410-420, or to step 425.

At optional step 410, the processing system (e.g., of a second screen device) may establish a wireless communication session between the device and the primary screen device, e.g., in connection with a presentation of a video program on the primary screen device where secondary content is to be presented via the second screen device. The wireless communication session may be initiated by the processing system (of the second screen device), by the primary screen device, or by both devices. The wireless communication session may comprise, for example, a peer-to-peer or local network-based wireless link, such as an IEEE 802.15 based link (e.g., Bluetooth, ZigBee, etc.), an IEEE 802.11 based link (e.g., Wi-Fi or Wi-Fi Direct), and so on.

At optional step 415, the processing system may receive a notification from the primary screen device when the primary screen device is to present the video program. For instance, in one example, optional step 410 may signal an intent to begin presenting a video program, while optional step 415 may indicate that the presentation of the video program has now started. In one example, step 415 identifies the video program, whereas step 410 may simply establish a wireless link via which communications between the primary screen device and second screen device are to flow.

At optional step 420, the processing system may request a timed event metadata set from a network-based server in response to receiving the notification from the primary screen device. The request may include an identification of the video program for which an associated timed event metadata set is being requested.

At step 425, the processing system receives the timed event metadata set associated with a video program. In one example, the timed event metadata set may be received from the network-based server to which the request was directed at optional step 420. In another example, the timed event metadata set may be sent by and received from the primary screen device. For instance, the primary screen device may have obtained the timed event metadata set at the same time or in conjunction with a request to a network-based server to stream and/or download the video program.

At step 430, the processing system receives a timestamp from the video program from the primary screen device. For instance, as described above, a primary screen device may be configured to periodically send timestamps indicating an elapsed time, a current frame, or other indications of a time in a video program to a second screen device via a wireless communication session.

At step 435, the processing system detects that the timestamp matches a timed event record from the timed event metadata set. For instance, the processing system may inspect event information of the timed event record (e.g., a start time field) in the timed event metadata set and determine that the start time matches the timestamp that is received. In one example, the processing system may inspect start time fields of a plurality of timed event records in the timed event metadata set to determine if one contains a match.

At step 440, the processing system accesses a secondary content in accordance with the timed event record in response to the detecting. For instance, the processing system may obtain one or more URLs from the timed event record that the processing system may use to request and receive the secondary content from a network-based server (e.g., a content server) in accordance with the present disclosure. In one example, the processing system may utilize the timed event record to select the secondary content, to select the network-based server from which to request the secondary content, and/or to determine a particular type of secondary content to request from a network-based server. For instance, different content servers may be provided for different types of content, different subject matter of the secondary contents, and so forth. In one example, the processing system may, in accordance with the timed event record, consider a viewer profile in order to personalize or tailor the secondary content to the viewer. For instance, the processing system may select between different secondary content depending upon a viewer profile and the interests of a particular viewer as set forth in the timed event record. To illustrate, the timed event record may include different URLs for accessing different secondary content associated with different interest categories. Thus, the processing system may select one (or more) of such URLs based upon a viewer profile and/or other criteria (such as a time of day, a physical location, a capability and/or a restriction of the second screen device, and so forth). In any case, at step 440 the processing system may direct a request to an appropriate network-based server and obtain the secondary content from the network-based server in accordance with the request.

At optional step 445, the processing system may transmit an instruction to the primary screen device to perform at least one action during a presenting of the secondary content. For instance, in one example, the method 400 may relate to the metadata event set 300 of FIG. 3, where line 8 of the metadata event set 300 has the value of the “pause” field set to “true.” In such an example, at optional step 445, the processing system may send an instruction to the primary screen device to pause the video program during the presenting of the secondary content. Alternatively, or in addition, the instruction may direct the primary screen device to display a certain graphic or to present other supplemental information (e.g., a company logo related to a commercial being presented via the second screen device, a message with instructions as to how to resume the video program, to troubleshoot problems with device interworking, and so forth), to substitute an alternative audio track, etc. The instruction may be sent via the wireless communication session that is established at optional step 410 as discussed above. In one example, the processing system may provide the supplemental information to the primary screen device. In another example, the instruction may direct the primary screen device to retrieve the supplemental information, e.g., via a URL associated with a network-based repository. It should be noted that in some examples, the video program is allowed to continue on the primary screen device while the secondary content is retrieved and presented via the second screen device. For instance, in an example where the method 400 relates to the metadata event set 300 of FIG. 3, if line 8 of the metadata event set 300 has the value of the “pause” field changed to “false,” then no instruction may be sent to the primary screen device (e.g., optional step 445 is not performed), or the instruction may direct the primary screen device to perform an action that does not involve pausing the video program.

At step 450, the processing system presents the secondary content on a screen of the device (e.g., the “second screen”). The presenting of the secondary content may vary depending upon the particular type of secondary content. For example, the secondary content may comprise at least one of, audio, video, or interactive content, such as: additional program information related to the video program, advertisements, interactive electronic content, such as social media content, quizzes, polling, food ordering, and so forth. In an example where the secondary content comprises video content, processing system may begin to present the secondary content (e.g., via an integrated or attached display screen of the second screen device) when it is obtained at step 440. In other examples, the secondary content 244 may be presented via an integrated or attached display screen (e.g., for text or interactive content), one or more audio speakers, headphones, etc. (e.g., for audio content), and so on.

At optional step 455, the processing system may transmit an instruction to the primary screen device to resume the video program after the presenting of the secondary content. The instruction may be sent via the wireless communication session that is established at optional step 410 as discussed above. In one example, optional step 455 may be performed in conjunction with optional step 445, i.e., in situations when the video program is paused at the primary screen device. However, when the video program is not paused while presenting the secondary content at step 450, optional step 455 may be omitted. Following step 450 or optional step 455, the method 400 proceeds to step 495 where the method ends.

It should be noted that the method 400 may be expanded to include additional steps or may be modified to include additional operations with respect to the steps outlined above. As just one example, optional step 415 may be performed prior to optional step 410. To illustrate, a primary screen device may send a wireless broadcast message to any capable device in range that it will begin presenting the video program, whereupon any second screen device that desires to be paired with the primary screen device for the video program may request to establish a wireless communication session with the primary screen device. In addition, the steps of the method 400 may be expanded to include the same or similar operations with respect to multiple second screen devices that may utilize respective copies of a timed event metadata set to present secondary contents in connection with the presentation of the video program on the primary screen device. In still another example, steps 430-455 may be repeated through various iterations of detecting that a timestamp matches a timed event record. Thus, these and other modification are all contemplated within the scope of the present disclosure.

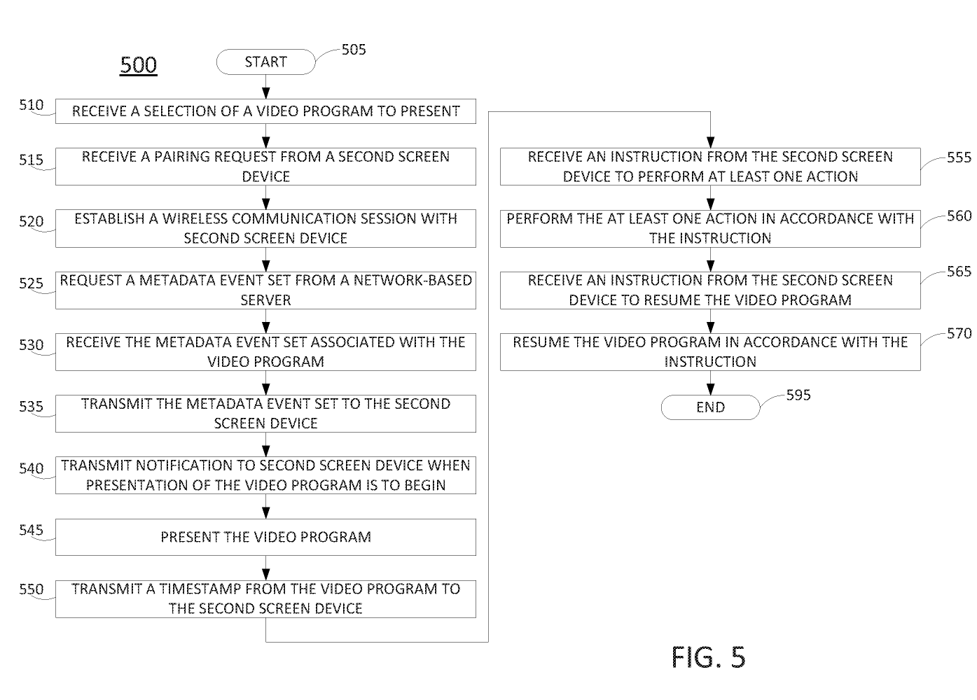

FIG. 5 illustrates a flowchart of an example method 500 for presenting a video program via a primary screen device in connection with a second screen device for presenting a secondary content, in accordance with the present disclosure. In one example, the method 500 is performed by primary screen device, or any one or more components thereof (such as a video player, a timer, an event handler, etc., e.g., a processor performing operations in accordance with instructions loaded into a memory), or by a primary screen device in conjunction with one or more other devices, such as a secondary screen device, an event server, a content server, and so forth. In one example, the steps, functions, or operations of method 500 may be performed by a computing device or system 600, and/or a processing system 602 as described in connection with FIG. 6 below. For instance, the computing device 600 may represent at least a portion of a primary screen device, or a system for presenting a secondary content in connection with a presentation of a video program on a primary screen device in accordance with the present disclosure. For illustrative purposes, the method 500 is described in greater detail below in connection with an example performed by a processing system, such as processing system 602. The method 500 begins in step 505 and proceeds to step 510.

At step 510, the processing system (e.g., of a primary screen device) receives a selection of a video program to present. For example, the processing system may receive the selection via a remote control, a mouse, a keypad, a touchscreen, via a voice command, or in another manner depending upon the particular type of primary screen device and the capabilities of such a device, based upon the type of video programming (e.g., broadcast television, on demand, DVR-recorded, IPTV, etc.), and so on.

At step 515, the processing system receives a paring request from a second screen device. For instance, a viewer may have selected the video program in connection with step 510 and may therefore be aware that the video program will be presented via the primary screen device. In addition, in accordance with the present disclosure, the viewer may request a pairing of the primary screen device with the secondary screen device. However, it should be noted that in another example, the processing system may initiate a pairing request or make a pairing offer to any second screen devices within wireless communication range, e.g., by sending a wireless broadcast message to any capable device in range that it will begin presenting the video program, whereupon any second screen device that desires to be paired with the primary screen device for the video program may request to establish a wireless communication session with the primary screen device.

At step 520, the processing system establishes the wireless communication session with the second screen device. The wireless communication session may comprise, for example, a peer-to-peer or local network-based wireless link, such as an IEEE 802.15 based link (e.g., Bluetooth, ZigBee, etc.), an IEEE 802.11 based link (e.g., Wi-Fi or Wi-Fi Direct), and so on. In one example, step 520 may be related to the operations of optional step 410 of the method 400, as described above.

At step 525, the processing system may request a timed event metadata set from a network-based server. For instance, as described above, in one example, a primary screen device may request a timed event metadata set from a network-based server (e.g., an event server).

At step 530, the processing system may receive the timed event metadata set associated with the video program, e.g., from a network-based server. For instance the processing system may request and receive the timed event metadata set from an event server. In one example, the processing system may receive the timed event metadata set along with the video program from a server from which the video program is obtained (which may also comprise the event server, or a different server).

At step 535, the processing system may transmit the timed event metadata set to the second screen device (and to any other second screen devices that may also be paired with the primary screen device in connection with the presentation of the video program). In such an example, the processing system may provide the timed event metadata set to the second screen device via the wireless communication session that is established at step 520.

At step 540, the processing system transmits a notification to the second screen device (and any other second screen devices that may also be paired with the primary screen device) when the presentation of the video program via the primary screen device is to begin. In one example, the notification may be sent via the wireless communication session that is established at step 520. In one example, step 540 may be related to the operations of optional step 415 of the method 400, as described above.

At step 545, the processing system presents the video program via the primary screen device. For instance, the video program may be presented via an integrated or attached display screen (e.g., the “primary screen”) of the primary screen device. In one example, the presenting of the video program may also include playing an audio portion of the video program via integrated or attached audio speakers, headphones, or the like, or wireless audio speakers (or wireless headphones) that are in communication with and controlled by the processing system.

At step 550, the processing system transmits a timestamp from the video program to the second screen device. The timestamps include information associated with the elapsed time within the video program that is being presented via the primary screen device (e.g., the time of a current frame, a value representing a time of an approaching frame, e.g., 5 seconds in advance of a particular frame, and so forth).

At step 555, the processing system receives an instruction from the second screen device to perform at least one action (i.e., during a presenting of secondary content at the second screen device). For instance, in accordance with the present disclosure, the timestamps may allow the second screen device to determine whether there is a timing match to a timed event record. In addition, where there is such a match, in one example the second screen device may begin presenting the secondary content on the second screen device and transmit the instruction that may be received at step 555. The instruction may be in accordance with step 445 of the method 400 discussed above. For instance, the instruction may be to pause the video program, to present supplemental information, to substitute an alternative audio track, and so forth. In one example, the instruction may be in accordance with the contents of one or more fields of a metadata event record. For instance, in an example where the method 500 relates to the metadata event set 300 of FIG. 3, the metadata event record 300 may cause the second screen device to send an instruction to pause the video program, e.g., in accordance with line 8 of the metadata event record 300 which has the “pause” field set to the value of “true.”

At step 560, the processing system perform the at least one action in accordance with the instruction that is received at step 555. For instance, the processing system may pause the video program, pause the video program and present supplemental information, substitute an alternative audio track, and so forth.

At step 565, the processing system receives an instruction from the second screen device to resume the presentation of the video program, e.g., in an example where the video program has been paused at step 560.

At step 570, the processing system resumes the video program in accordance with the instruction. For instance, the processing system may cause the presentation of the video program to be resumed via an integrated or attached display screen and/or audio speakers, headphones, etc. Following step 570, the method 500 proceeds to step 595 where the method ends.

It should be noted that the method 500 may be expanded to include additional steps or may be modified to include additional operations with respect to the steps outlined above. For example, the method 500 may be expanded to include repeating the steps 545-570 through multiple iterations, e.g., where a second screen device determines that an additional timestamp matches another timed event record. In another example, the second screen device may obtain the timed event metadata set without the involvement of the processing system. In such an example, steps 525-535 may be omitted from the method 500. Thus, these and other modification are all contemplated within the scope of the present disclosure.

In addition, although not expressly specified above, one or more steps of the method 400 or the method 500 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 4 or FIG. 5 that recite a determining operation or involve a decision do not necessarily require that both branches of the determining operation be practiced. In other words, one of the branches of the determining operation can be deemed as an optional step. Furthermore, operations, steps or blocks of the above described method(s) can be omitted, combined, separated, and/or performed in a different order from that described above, without departing from the example embodiments of the present disclosure. For instance, any one or more steps of the above recited methods may comprise optional steps in various additional examples.

FIG. 6 depicts a high-level block diagram of a computing device or processing system specifically programmed to perform the functions described herein. As depicted in FIG. 6, the processing system 600 comprises one or more hardware processor elements 602 (e.g., a central processing unit (CPU), a microprocessor, or a multi-core processor), a memory 604 (e.g., random access memory (RAM) and/or read only memory (ROM)), a module 605 for presenting a secondary content in connection with a presentation of a video program on a primary screen device and/or for presenting a video program via a primary screen device in connection with a second screen device for presenting a secondary content, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 400 or the method 500 as discussed above is implemented in a distributed or parallel manner for a particular illustrative example, i.e., the steps of the above method 400 or method 500, or the entire method 400 or method 500 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 602 can also be configured or programmed to cause other devices to perform one or more operations as discussed above. In other words, the hardware processor 602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the methods discussed above can be used to configure a hardware processor to perform the steps, functions and/or operations of the above disclosed method 400 or method 500. In one example, instructions and data for the present module or process 605 for presenting a secondary content in connection with a presentation of a video program on a primary screen device and/or for presenting a video program via a primary screen device in connection with a second screen device for presenting a secondary content (e.g., a software program comprising computer-executable instructions) can be loaded into memory 604 and executed by hardware processor element 602 to implement the steps, functions, or operations as discussed above in connection with the illustrative method 400 or method 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 605 for presenting a secondary content in connection with a presentation of a video program on a primary screen device and/or for presenting a video program via a primary screen device in connection with a second screen device for presenting a secondary content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

1. A device, comprising:
a processing system including at least one processor; and
a computer-readable medium storing instructions which, when executed by the processing system, cause the processing system to perform operations, the operations comprising:
receiving a timed event metadata set associated with a video program;
receiving a plurality of timestamps associated with the video program from a primary screen device, wherein each of the plurality of timestamps comprises an indication of a current time of the video program as the video program is played on the primary screen device;
detecting that a first timestamp of the plurality of timestamps matches a timed event record from the timed event metadata set;
accessing a secondary content in accordance with the timed event record in response to the detecting; and
presenting the secondary content on a screen of the device.

2. The device of claim 1, wherein the operations further comprise:
establishing a wireless communication session between the device and the primary screen device, wherein the plurality of timestamps is received via the wireless communication session.

3. The device of claim 2, wherein the wireless communication session comprises an institute of electrical and electronics engineers 802.15 connection.

4. The device of claim 2, wherein the wireless communication session comprises an institute of electrical and electronics engineers 802.11 connection.

5. The device of claim 1, wherein the operations further comprise:
receiving a notification from the primary screen device when the primary screen device is to present the video program.

6. The device of claim 5, wherein the operations further comprise:
requesting the timed event metadata set from a network-based server in response to receiving the notification from the primary screen device, wherein the timed event metadata set is received from the network-based server.

7. The device of claim 5, wherein the timed event metadata set is received from the primary screen device.

8. The device of claim 1, wherein the accessing the secondary content comprises:
requesting the secondary content from at least one network-based server, in response to the detecting that the first timestamp matches the timed event record; and
receiving the secondary content from the at least one network-based server.

9. The device of claim 8, wherein the accessing the secondary content further comprises:
selecting the secondary content to be requested based upon a profile associated with the device in accordance with the timed event record.

10. The device of claim 1, wherein the operations further comprise:
transmitting an instruction to the primary screen device to perform at least one action during the presenting of the secondary content.

11. The device of claim 1, wherein the operations further comprise:
transmitting a first instruction to the primary screen device to pause the video program during the presenting of the secondary content; and
transmitting a second instruction to the primary screen device to resume the video program after the presenting of the secondary content.

12. The device of claim 11, wherein the operations further comprise:
establishing a wireless communication session between the device and the primary screen device, wherein the plurality of timestamps is received via the wireless communication session, and wherein the first instruction to the primary screen device to pause the video program and the second instruction to the primary screen device to resume the video program are transmitted via the wireless communication session.

13. The device of claim 1, wherein the secondary content comprises at least one of:
a secondary video program;
a text content; or
an audio content.

14. The device of claim 1, wherein the secondary content comprises an interactive electronic content comprising at least one of:
a voting content;
a quiz content; or
a survey content.

15. The device of claim 1, wherein the timed event record from the timed event metadata set comprises:
a start time;
a duration; and
an identification of the secondary content.

16. The device of claim 15, wherein the timed event record from the timed event metadata set further comprises:
a category associated with the secondary content.

17. The device of claim 16, wherein the secondary content is one of a plurality of secondary contents, wherein the category is one of a plurality of interest categories, and wherein each of the plurality of interest categories is associated with a respective one of the plurality of secondary contents.

18. The device of claim 1, wherein the device comprises a secondary screen device, wherein the primary screen device is configured to establish wireless communication sessions with a plurality of secondary screen devices including the secondary screen device to transmit the plurality of timestamps including the first timestamp associated with the video program.

19. A non-transitory computer-readable medium storing instructions which, when executed by a processing system including at least one processor, cause the processing system to perform operations, the operations comprising:
receiving a timed event metadata set associated with a video program;
receiving a plurality of timestamps associated with the video program from a primary screen device, wherein each of the plurality of timestamps comprises an indication of a current time of the video program as the video program is played on the primary screen device;
detecting that a first timestamp of the plurality of timestamps matches a timed event record from the timed event metadata set;
accessing a secondary content in accordance with the timed event record in response to the detecting; and
presenting the secondary content on a screen of the device.

20. A method comprising:
receiving, by a processing system including at least one processor, a timed event metadata set associated with a video program;
receiving, by the processing system, a plurality of timestamps associated with the video program from a primary screen device, wherein each of the plurality of timestamps comprises an indication of a current time of the video program as the video program is played on the primary screen device;
detecting, by the processing system, that a first timestamp of the plurality of timestamps matches a timed event record from the timed event metadata set;
accessing, by the processing system, a secondary content in accordance with the timed event record in response to the detecting; and
presenting, by the processing system, the secondary content on a screen of the device.
